(19) United States
(12) Patent Application Publication
(10) Pub. No.: US 2013/0170760 A1
(43) Pub. Date: Jul. 4, 2013

(54) Method and System for Video Composition

(71) Applicants: Lei Wang, Clovis, CA (US); Farzin Aghdasi, Clovis, CA (US); Greg Millar, Coarsegold, CA (US)

(72) Inventors: Lei Wang, Clovis, CA (US); Farzin Aghdasi, Clovis, CA (US); Greg Millar, Coarsegold, CA (US)

(73) Assignee: PELCO, INC., Clovis, CA (US)

(21) Appl. No.: 13/339,758

(22) Filed: Dec. 29, 2011

(51) Int. Cl. G06K 9/00

(52) U.S. Cl. CPC G06K 9/00711
USPC 382/224

(57) ABSTRACT

A method of presenting video comprising receiving a plurality of video data from a video source, analyzing the plurality of video data; identifying the presence of foreground-objects that are distinct from background portions in the plurality of video data, classifying the foreground-objects into foreground-object classifications, receiving user input selecting a foreground-object classification, and generating video frames from the plurality of video data containing background portions and only foreground-objects in the selected foreground-object classification.

### CROSS REFERENCES

This Application is related to U.S. patent application Ser. No, 12/982,601, entitled “Searching Recorded Video” filed on Dec. 30, 2010, the entire disclosure of which is incorporated by reference for all purposes.

This Application is related to U.S. patent application Ser. No. 12/982,602, entitled “Video Coding” filed on Dec. 30, 2010, the entire disclosure of which is incorporated herein by reference for all purposes.

### BACKGROUND

In surveillance systems the operator may be required to monitor a large number of displays showing different scenes captured by a plurality of cameras in the system. The displays may also contain multiple windows in which the video from different cameras in the system are displayed. An operator may lose concentration and focus in performing this monitoring function because of the number of different scenes to monitor and the amount of activity occurring in the various scenes. Accordingly, there is a need in the industry for a method and system to provide a user with a display that enables a user to focus more effectively on the video information that a user needs to monitor.

In addition, the large amount of video data captured by a surveillance system increases the complexity of forensic video searching and increases the need for a method of presenting the results of analysis, searches, or events in an easily understood and informative manner.

### SUMMARY

An example of a method of presenting video includes receiving a plurality of video data from a video source, analyzing the plurality of video data; identifying the presence of foreground-objects that are distinct from background portions in the plurality of video data with associated video content metadata such as object location, size, color, and so on, classifying the foreground-objects into different foreground-object classifications, receiving user input selecting a foreground-object classification, and generating video frames or still pictures from the plurality of video data containing background portions and only foreground-objects in the selected foreground-object classification.

Implementations of such a method may include one or more of the following features. The method further includes the steps of processing data associated with a foreground-object in a selected foreground-object classification based on a first update rate, processing data associated with the background portions based on a second update rate, transmitting data associated with a foreground-object in a selected foreground-object classification based dynamically, and transmitting data associated with the background portions based on the second update rate, wherein the first update rate is greater than the second update rate. The method further includes the steps of receiving a user request for a storyboard image for a first foreground-object classified in a selected foreground-object classification, analyzing the generated video frames to obtain a plurality of frames containing the first foreground-object, and generating an image containing background portions and a plurality of images of the first foreground-object showing motion of the first foreground-object over a period of time. The step of generating an image containing background portions and a plurality of images of the first foreground-object showing motion of the first foreground-object over a period of time includes generating an image containing background portions and a plurality of images of the first foreground-object showing motion of the first foreground-object over a period of time without having any overlap between the plurality of images of the first foreground-object. The step of generating an image containing background portions and a plurality of images of the first foreground-object showing motion of the first foreground-object over a period of time further includes generating a line showing the direction of motion of the first foreground-object. The step of generating a line showing the direction of motion of the first foreground-object comprises genrerating a line showing the direction of motion of the first foreground-object and an indication of a time period for the movement of the first foreground-object along the line. The step of generating video frames from the plurality of video data containing background portions and only foreground-objects in the selected foreground-object classification includes the step of stitching the foreground-objects in the selected foreground-object classification onto the background portions. The step of generating video frames from the plurality of video data containing background portions and only foreground-objects in the selected foreground-object classification includes the step of stitching the foreground-objects in the selected foreground-object classification at different time onto the background portions. The step of classifying the foreground-objects into foreground-object classifications includes the steps of calibrating the object with perspective transform to determine the physical size; initially classifying the object based on its physical size and moving direction with either Gaussian probability modes or deterministic models; determining if the object size is between the size of a group of people and a vehicle; smoothing the vertical shape profile of the motion blob if the object size is between the size of a group of people and a vehicle; and analyzing the smoothed vertical shape profile of the motion blob to identify the object as either a group of people or vehicle based on the number of peaks on the profile.

An example of a system for presenting video includes a processor adapted to receive a plurality of video data from a video source, analyze the plurality of video data, identify the presence of foreground-objects that are distinct from background portions in the plurality of video data, classify the foreground-objects into foreground-object classifications, receive user input selecting a foreground-object classification, and generate video frames from the plurality of video data containing background portions and only foreground-objects in the selected foreground-object classification.

Implementations of such a system may include one or more of the following features. The processor is further adapted to process data associated with a foreground-object in a selected foreground-object classification based on a first update rate, process data associated with the background portions based on a second update rate, transmit data associated with a foreground-object in a selected foreground-object classification dynamically, and transmit data associated with the background portions based on the second update rate, wherein the first update rate is greater than the second update rate. The processor is further adapted to receive a user request for a storyboard image for a first foreground-object classified in a selected foreground-object classification, to analyze the generated video frames to obtain a plurality of frames containing the first foreground-object, and generate an image containing background portions and a plurality of images of the first foreground-object showing motion of the first foreground-object over a period of time. The processor is further adapted to generate an image containing background portions and a plurality of images of the first foreground-object showing motion of the first foreground-object over a period of time without having any overlap between the plurality of images of the first foreground-object. The processor is further adapted to generate an image containing background portions, a plurality of images of the first foreground-object showing motion of the first foreground-object over a period of time, and a line showing the direction of motion of the first foreground-object. The processor is further adapted to generate a line showing the direction of motion of the first foreground-object and an indication of a time period for the movement of the first foreground-object along the line. The processor is adapted to stitch the foreground-objects in the selected foreground-object classification onto the background portions.

An example of a non-transitory computer readable medium includes instructions configured to cause a processor to receive a plurality of video data from a video source, analyze the plurality of video data, identify the presence of foreground-objects that are distinct from background portions in the plurality of video data, classify the foreground-objects into foreground-object classifications, receive user input selecting a foreground-object classification, and generate video frames from the plurality of video data containing background portions and only foreground-objects in the selected foreground-object classification.

Implementations of such a non-transitory computer readable medium may include one or more of the following features. The non-transitory computer readable medium further includes instructions configured to cause the processor to process data associated with a foreground-object in a selected foreground-object classification based on a first update rate, process data associated with the background portions based on a second update rate; transmit data associated with a foreground-object in a selected foreground-object classification dynamically, and transmit data associated with the background portions based on the second update rate, wherein the first update rate is greater than the second update rate. The non-transitory computer readable medium further comprising instructions configured to cause the processor to receive a user request for a storyboard image for a first foreground-object classified in a selected foreground-object classification; analyze the generated video frames to obtain a plurality of frames containing the first foreground-object, and generate an image containing background portions and a plurality of images of the first foreground-object showing motion of the first foreground-object over a period of time. The instructions to generate an image containing background portions and a plurality of images of the first foreground-object showing motion of the first foreground-object over a period of time include instructions configured to cause the processor to generate an image containing background portions and a plurality of images of the first foreground-object showing motion of the first foreground-object over a period of time without having any overlap between the plurality of images of the first foreground-object. The instructions to generate an image containing background portions and a plurality of images of the first foreground-object showing motion of the first foreground-object over a period of time farther include instructions configured to cause the processor to generate a line showing the direction of motion of the first foreground-object. The instructions configured to cause the processor to generate a line showing the direction of motion of the first foreground-object comprise instructions to cause a processor to generate a line showing the direction of motion of the first foreground-object and an indication of a time period for the movement of the first foreground-object along the line. The instructions to generate video frames from the plurality of video data containing background portions and only foreground-objects in the selected foreground-object classification include instructions to cause a processor to stitch the foreground-objects in the selected foreground-object classification onto the background portions.

The processes and systems described herein, and the attendant advantages, applications, and features thereof, will be more fully understood by a review of the following detailed description, figures, and claims.

### BRIEF DESCRIPTION OF THE DRAWINGS

FIG. 1 is a simplified diagram of a high definition video transmission system, including a transmitter and a receiver.

FIG. 2 is an exemplary block diagram of components of the transmitter shown in FIG. 1.

FIG. 3 is an exemplary block diagram of components of the receiver shown in FIG. 1.

FIG. 4 is a block flow diagram of an exemplary process for encoding video.

FIG. 5 is a block flow diagram of an exemplary process for decoding video.

FIG. 6 is a flow diagram of an exemplary process for object classification in video content captured by a video camera.

FIG. 7 illustrates a flow diagram for an exemplary embodiment of a process for composing an image for display

FIG. 8 is an exemplary illustration of a storyboard image created using one or more discussed embodiments.

In the figures, components with similar relevant characteristics and/or features can have the same reference label.

### DETAILED DESCRIPTION

Techniques are discussed herein for providing mechanisms for analyzing and presenting video content efficiently and effectively. In particular, foreground-objects are identified as distinct from the background of a scene represented by a plurality of video frames. In identifying foreground-objects, semantically significant and semantically insignificant movement (e.g., non-repetitive versus repetitive movement) is differentiated. For example, the swaying motion of a tree's leaves being minor and repetitive can be determined to be semantically insignificant and to belong in a scene's background. The video can be processed in a frame rate but the objects can be transmitted dynamically. In our implementation, the object will be updated based on time and space criteria. If the object moves over a predefined distance, it needs to be updated, otherwise if it stays over a period of time, it will be updated again at a predefined rate (first update rate). So the first update rate will not be 30 frames per second. It can be 1 frame per second or slower.

Techniques described herein can be used to communicate video and associated metadata over various communication systems. For example, high definition video and associated metadata can be transmitted over various wired and wireless communications systems, such as Ethernet-based, Coaxial-based, Powerline-based, WiFi-based (802.11 family standards), Code Division Multiple Access (CDMA), Time Division Multiple Access (TDMA), Frequency Division Multiple Access (FDMA), Orthogonal FDMA (OFDMA), Single-Carrier FDMA (SC-FDMA) systems, etc.

As used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). A wireless communication network does not have all communications transmitted wirelessly, but is configured to have at least some communications transmitted wirelessly.

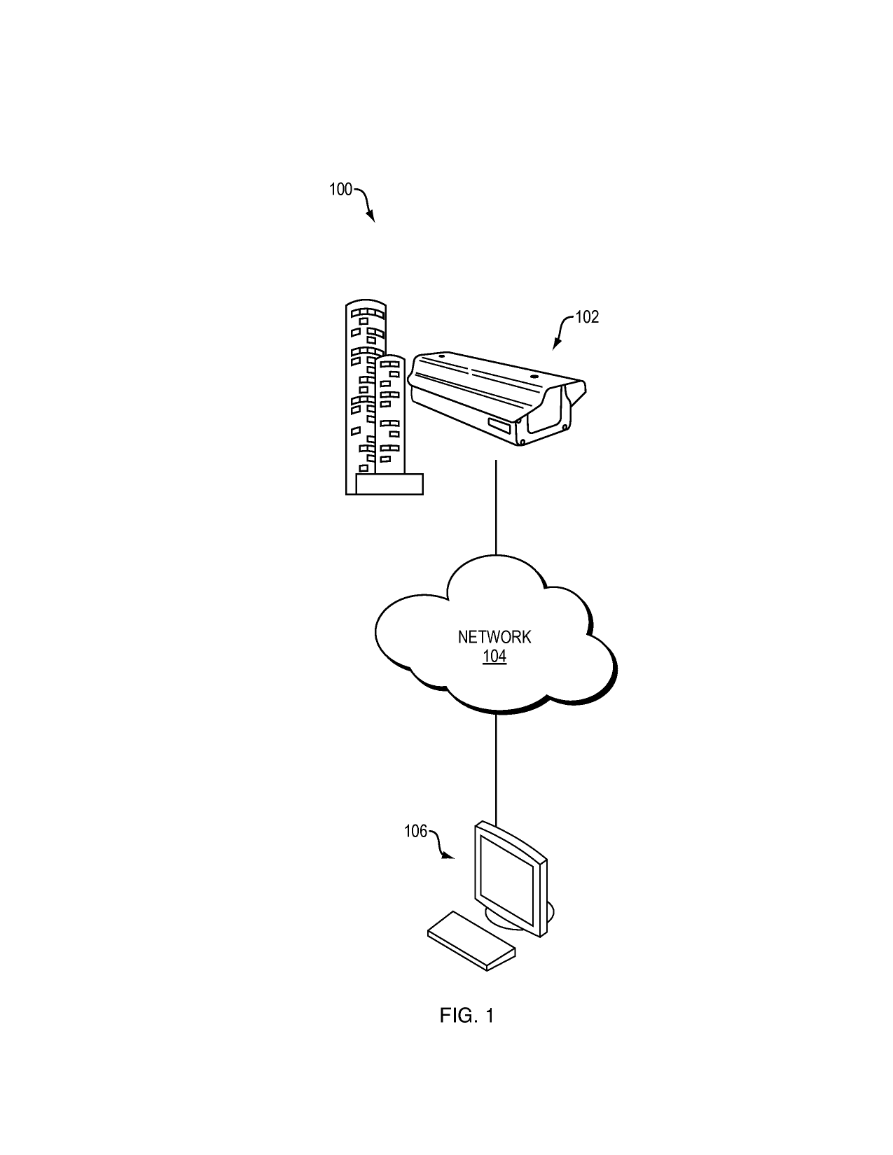

Referring to FIG. 1, a simplified diagram of a video transmission system, including a transmitter and a receiver, is shown. Video and metadata transmission system 100 includes transmitter 102, network 104, and receiver 106. Transmitter 102 is preferably a device for encoding, analyzing, and transmitting, for example, high definition video and video content metadata. For example, transmitter 102 can be a video capturing device (for example, a computing device including a camera, an intelligent camera, a video grabber, and others of the same type), a computing device (for example, desktop computer, laptop, tablet device, computer server, a video transcoder, and others of the same type) connected to one or more video capturing devices (for example, external cameras) and/or video encoding devices, a module of a video capturing device, a module of a computing device, and/or the like. For example, transmitter 102 can be a module embedded within a camera or a module of a video transcoder. As used herein, video includes full-motion video and still photographs taken at intervals. Receiver 106 is preferably a device for receiving and decoding, for example, high definition video and metadata. Receiver 106 can be, for example, a desktop computer, a laptop, a tablet device, a computer server, a mobile device, a mobile telephone, a monitoring system, and/or the like.

Network 104 is preferably any suitable network for facilitating communications between two or more devices. For example, network 104 can be a closed loop communications system, a local area network (such as an intranet), a wide area LAN (such as, the Internet), and/or the like. Transmitter 102 is configured to transmit encoded images and other data, such as metadata, to receiver 106 through network 104. For example, transmitter 102 can provide receiver 106 with a series of encoded images that can be decoded into a video stream (for example, high definition video) for presentation to a user. To support the encoding and decoding of images, transmitter 102 can further provide event information (for example, an indication that a new object has appeared in a video stream, and so forth) to receiver 106.

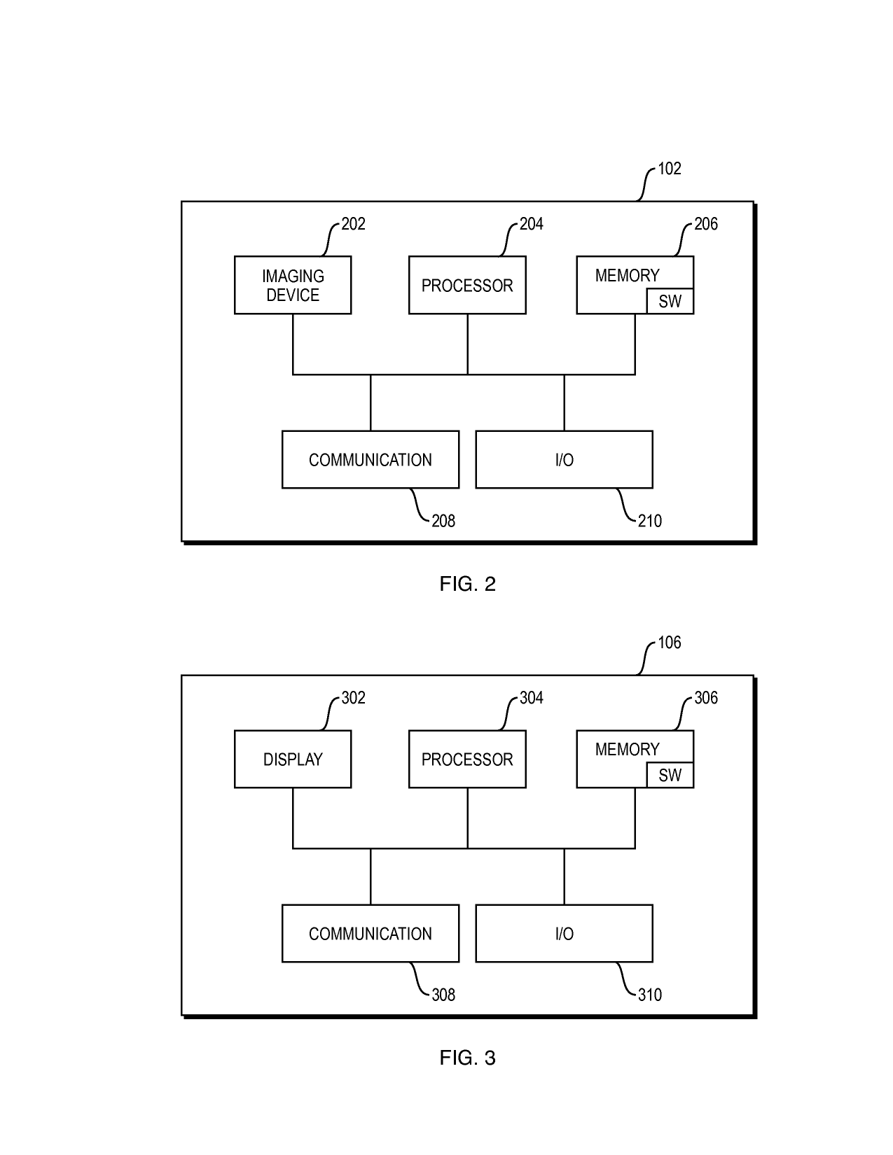

Referring to FIG. 2, transmitter 102 includes imaging device 202, processor 204, memory 206, communication subsystem 208, and input/output (I/O) subsystem 210. Processor 204 is preferably an intelligent hardware device, for example, a central processing unit (CPU), such as those made by the Intel® Corporation, AMD®, ARM™, a microcontroller, an application specific integrated circuit (ASIC), a digital signal processor (DSP) (for example, Texas Instrument's DaVinci™ family DSPs), and others of the same type. Memory 206 includes a physical and/or tangible storage medium. Such a medium can take many forms, including but not limited to, non-volatile media and volatile media. Non-volatile media include, for example, optical and/or magnetic disks, such as read-only memory (ROM). Illustratively, non-volatile media can be a hard drive, flash drive, and/or the like. Volatile media include, without limitation, various types of random access memory (RAM). Illustratively, volatile media can be dynamic random access memory (DRAM), static random access memory (SRAM), and/or the like. Memory 206 stores computer-readable, computer executable software code containing instructions that are configured to, when executed, cause processor 204 to perform various functions described herein. The functions implement a video transmission system. In some implementations, memory 206 can store object and background images. For example, memory 206 can store the images of foreground-objects detected in a plurality of frames received from imaging device 202. Memory 206 can further store an objects list that includes identifiers, object images, references, and/or other attributes corresponding to each detected foreground-object.

Imaging device 202 is preferably any suitable combination of hardware and/or software for capturing raw video data, for example, devices based on charge-coupled device (CCD), complementary metal oxide semiconductor (CMOS) image sensor technologies, and/or thermal imaging sensors, etc. Transmitter 102 can include any number of imaging devices (including zero).

Transmitter 102 can additionally or alternatively receive raw or encoded video data from external video capturing devices and/or video encoding devices (for example, external cameras, computing devices generating encoded video, and so forth) that are directly connected to one or more ports of communication subsystem 208 and/or one or more ports of I/O subsystem 210.

Communication subsystem 208 is preferably any suitable combination of hardware and/or software for communicating with other devices (for example, receiver 106 shown in FIG. 3, other cameras, and others of similar type). Communication subsystem 208 can be configured to connect to, for example, a closed-loop communications system, a local area network (for example, an intranet), a wide area network (for example, the Internet), and others of similar type. I/O subsystem 210 is preferably any suitable combination of hardware and/or software for managing communications with and/or the operations of input/output devices.

Video data received by transmitter 102 can be encoded or compressed into a digital format by processor 204. For example, transmitter 102 can perform analysis on, identify foreground-object and background portions in, encode, and transmit data according to one or more update rates. Encoded video data can be streamed or transmitted to receiver 106 via network 104.

Referring to FIG. 3, receiver 106 includes display 302, processor 304, memory 306, communication subsystem 308, and I/O subsystem 310. Processor 304 is preferably an intelligent hardware device, for example, a central processing unit (CPU) such as those made by the Intel® Corporation, AMD®, ARM™, a microcontroller, an application specific integrated circuit (ASIC), a digital signal processor (DSP), and others of similar type. Memory 306 includes a physical and/or tangible storage medium. Such a medium can take many forms, including but not limited to, non-volatile media and volatile media. Non-volatile media include, for example, optical and/or magnetic disks, such as read-only memory (ROM). Illustratively, non-volatile media can be a hard drive, flash drive, and/or the like. Volatile media include, without limitation, various types of random access memory (RAM). Illustratively, volatile media can be dynamic random access memory (DRAM), static random access memory (SRAM), and/or the like. Memory 306 stores computer-readable, computer-executable software code containing instructions that are configured to, when executed, cause processor 304 to perform various functions described herein. The functions implement a video transmission system. In some implementations, memory 306 can store foreground-object and background images. For example, memory 306 can store the images of foreground-objects. Memory 306 can further store an objects list that includes identifiers, object images, references, and/or other attributes corresponding to each detected foreground-object.

Communication subsystem 308 preferably is any suitable combination of hardware and/or software for communicating with other devices (for example, the transmitter shown in FIG. 3). Communication subsystem 308 can be configured to connect to, for example, a closed-loop communications system, a local network, a wide area network (for example, the Internet), and others of similar type. Display 302 is preferably any suitable device for displaying images to a user, such as a cathode ray tube (CRT) monitor, a liquid crystal display (LCD) monitor, a plasma-based monitor, a projector, and others of similar type. I/O subsystem 310 is preferably any suitable combination of hardware and/or software for managing communications with and/or the operations of input/output devices, such as a keyboard, mouse, touchpad, scanner, printer, camera, and others of similar type. Devices such as a keyboard, mouse, and touchpad can be utilized by a user to provide user input to processor 304 to provide user selection choices on foreground objects to be stitched to a background image for display or use by a user as discussed in detail below.

While the various configurations described herein are directed to the presentation of video, it should be appreciated that modifications can be made to cover other contexts. For example, modifications can be made to enable RADAR, LIDAR and other object based detection monitoring over low bandwidth connections.

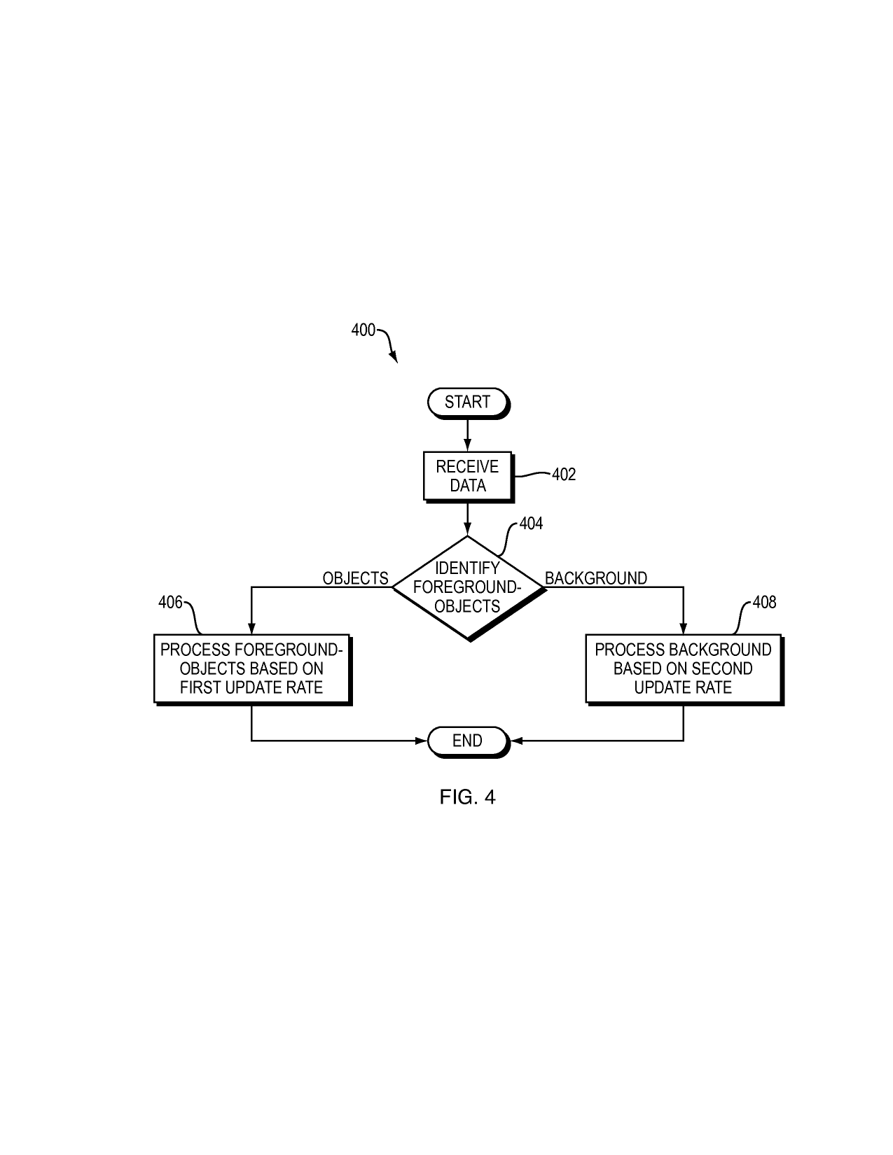

Referring to FIG. 4, with further reference to FIGS. 1 and 2, process 400 for encoding video includes the blocks shown. Process 400 is, however, exemplary only and not limiting. Process 400 can be altered, e.g., by having blocks added, removed, rearranged, and/or performed concurrently. For example, blocks 406 and 408 for processing foreground-objects and a background can be performed concurrently. Still other alterations to process 400 as shown and described are possible.

Process 400 can begin at block 402 by receiving a video frame from a video source, such as an imaging device. At block 404, process 400 applies a Gaussian mixture model for excluding static background images and images with semantically insignificant motion (e.g., a flag waving in the wind). Based on the application of the Gaussian model, foreground-objects (that is, objects of interest) can be identified in the received frame as distinct from the frame's background. At block 406, foreground-objects are processed based on a first update rate. Additional information is also transmitted as video content metadata. For example, object events, such as the appearance, loss, or movement of an object in a given frame, can be transmitted. At block 408, portions of the frame identified as a part of the background are processed based on a second update rate. For example, an update rate may specify that a background is to be updated every fifteen minutes. As a result, an encoded background image is generated and transmitted once every fifteen minutes. The coding of objects and background is optional. If the background and objects are not embedded in the metadata, the video contents need to be decoded at a server to recreate the background image and extract objects at the time of presentation.

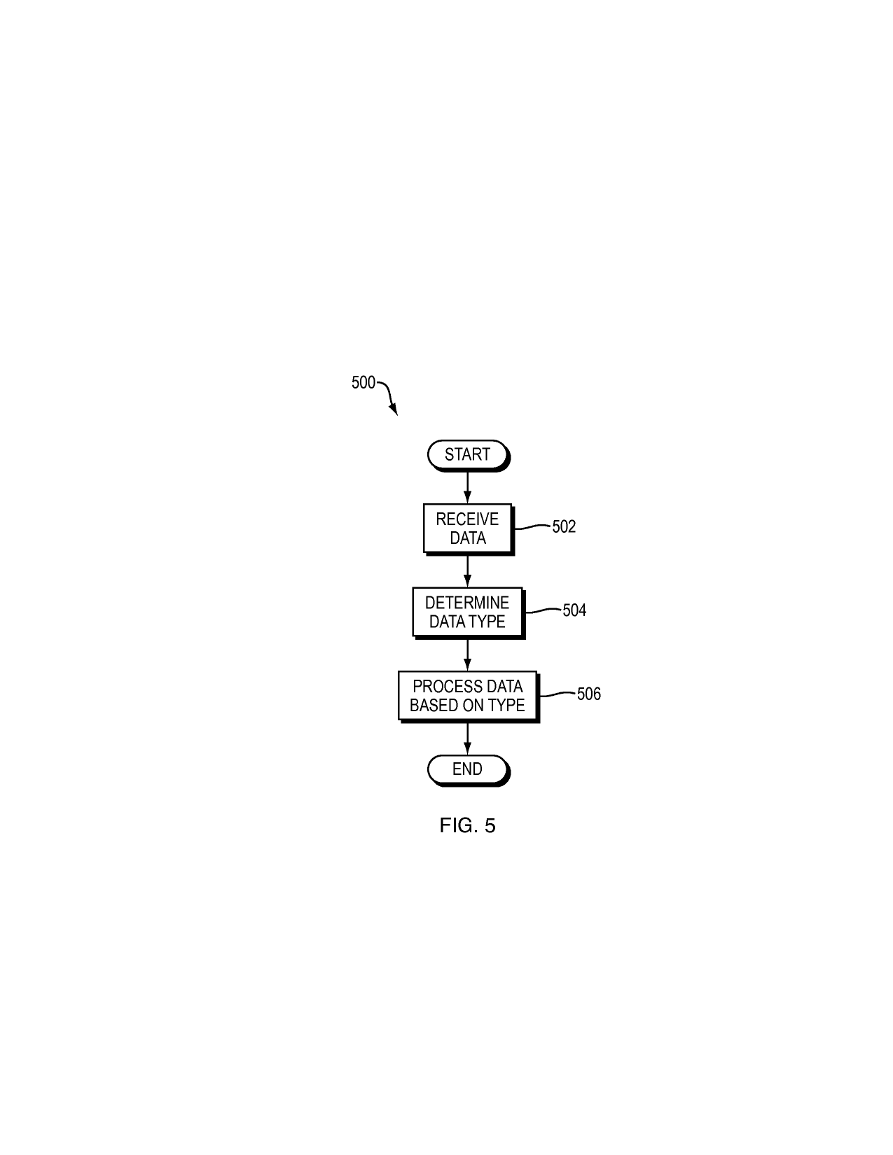

Referring to FIG. 5, with further reference to FIGS. 1 and 3, process 500 for decoding of video includes the blocks shown. Process 500 is, however, exemplary only and not limiting. Process 500 can be altered, e.g., by having blocks added, removed, rearranged, and/or performed concurrently.

Process 500 can begin at block 502 by receiving data. Data can include encoded images and/or event information. At block 504, process 500 can determine a data type for the received data. Data types can include event, background, moving object, and still object types. At block 506, the received data is processed based on the identified object type. For example, if the data is of an event type, objects can be added or removed from an objects list, which is used for the tracking of objects within the frames of a video stream. As another example, if the data is of a background type, the data can be decoded and stitched to foreground-objects in order to generate a video frame that can be presented to a user. As still another example, if the data is of an object type, the data can be decoded and stitched with other images (for example, other object images, a background image, and others of similar type) in order to generate a video frame that can be presented to a user.

As a result of processes 400 and 500, a video stream including a plurality of video frames with associated video content metadata can be presented to a user via a receiver, such as a computer workstation.

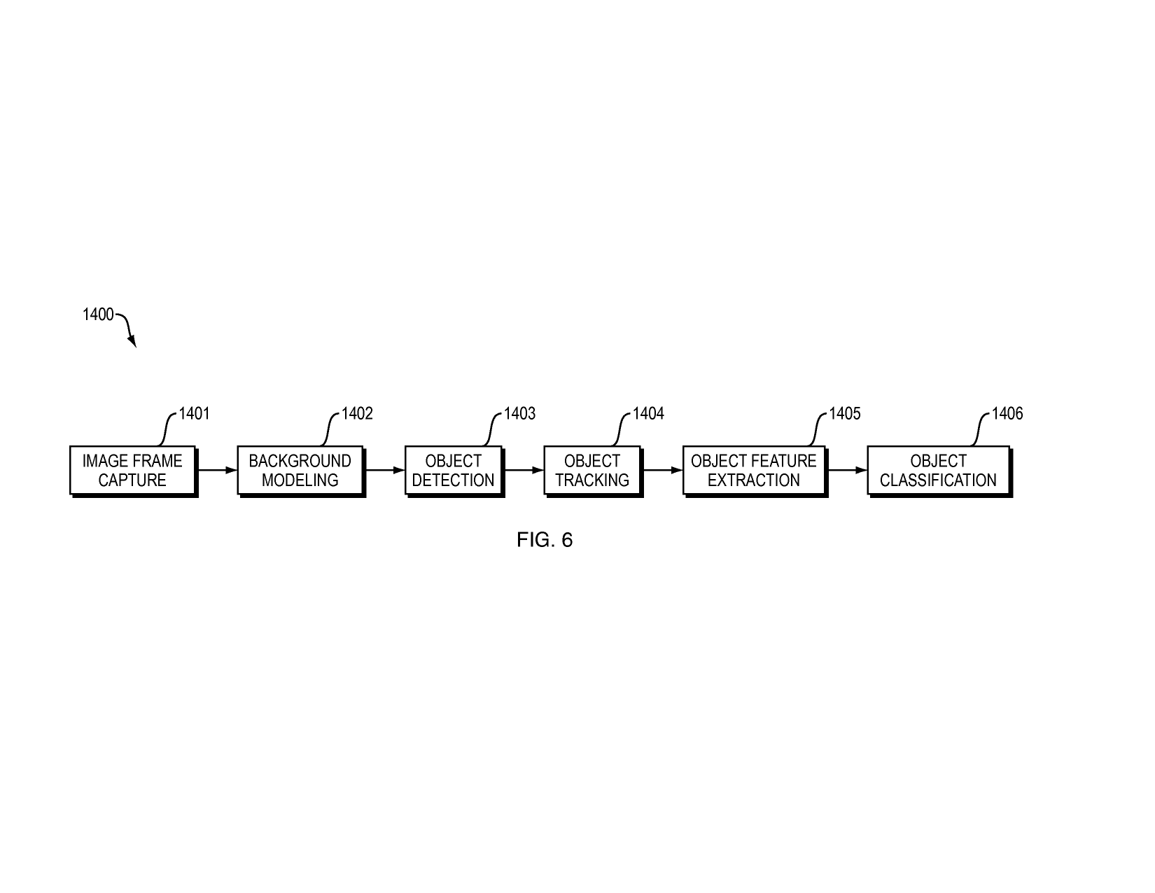

FIG. 6 is a flow diagram of an exemplary process 1400 for object classification in video content captured by a video camera. At block 1401, frames of video content are captured by a video camera, such as transmitter 102 in FIG. 1. The captured image frames are processed by, for example, processor 204 in FIG. 2 or processor 304 in FIG. 3, to model the background of the camera's field of view in block 1402. As discussed previously, a model of the background can be created to identify which items in the camera's field of view belong to the background and which are in the foreground. Items in the background, such as trees, rocks, signs, furniture, and other such background items, do not need to be tracked or classified by the video analytics algorithms. Various techniques can be used to develop the model of the background, such as mixture Gaussian model, running average, and non-parametric approaches. Other techniques can also be used to create the model of the background. Once the model of the background has been developed, foreground pixels can then be extracted from the video content captured by the video camera (for example, transmitter 102) by processor 204, and the foreground pixels can then be grouped together to form motion blocks at block 1403 by processor 204. Objects can then be tracked by processor 204 over successive frames of the video content at block 1404, and processor 204 can extract object features for each tracked object at block 1405. Then at block 1406, processor 204 can classify objects using the extracted object features.

A single person can be classified from a vehicle or group of people according to the aspect ratio, physical size and vertical profile of the shape of the object. The field of view of the camera is calibrated with a perspective transform method. With the perspective transform, the object can get its physical size at different locations based on the assumption that the bottom of the object is on the ground plane. From the calibrated object size, the classification result can be refined. If the width of an object is between 0.5 to 1.2 meters and the height to width ratio is between 1.5 to 4, the object can be classified as person. If the width of an object is over 3 meters and its height to width aspect ratio is between 0.1 to 0.7 and its moving direction is left or right, it can be classified as vehicle. If the width of object is over 1.5 meters and its height to width aspect ratio is over 2 and its moving direction is up or down, the object is classified as vehicle. The method proposed above can be updated with a Gaussian model. Given a mean and standard deviation of a variable of each category, the probability of category can be estimated. For example, for person detection, let μ_{pw}=0.8 be the average width of person and σ_{pw}=0.3 be the standard deviation of the width of person, μₚᵣ=2.7 be the average of the height to width aspect ratio and σₚᵣ=1.2 be the standard deviation of the height to width aspect ratio of person, then

$${P}_{person} ( w , r ) = \frac{1}{2 {πσ}_{pw} {σ}_{pr}} {e}^{- \frac{{( w - {μ}_{pw} )}^{2} + {( r - {μ}_{pr} )}^{2}}{2 {σ}_{pw}^{2}}} .$$

As such, the category of vehicle can be derived similarly. If the width of an object is between 1.5 and 3 meters and its height to width aspect ratio is around 1, it could be a vehicle or a group of people. This can be estimated with a Gaussian model as well. The object classification will be the model with highest probability. A group of people and a vehicle can be differentiated via the vertical shape profiles of the motion blob. A vertical shape profile is a curve that indicates the top shape of the object. The profile should be smoothed before further processing to remove noises. A Gaussian filter or median filter can be applied. In general, the vehicle contains one peak in its vertical shape profile, and the people group will have more than one peak in its vertical shape profile. Otherwise, the object will be classified as unknown. This classification result is updated with a category histogram for each tracked object. Along with the object tracking, the classification results can be different, when this happens, the most probable classification will be determined via the probability distribution of the categories. A confidence score will be given to the category of each object based on the probability distribution of the classification results. The probability distribution will be updated periodically. This is just one classification method, other classification methods can also be applied

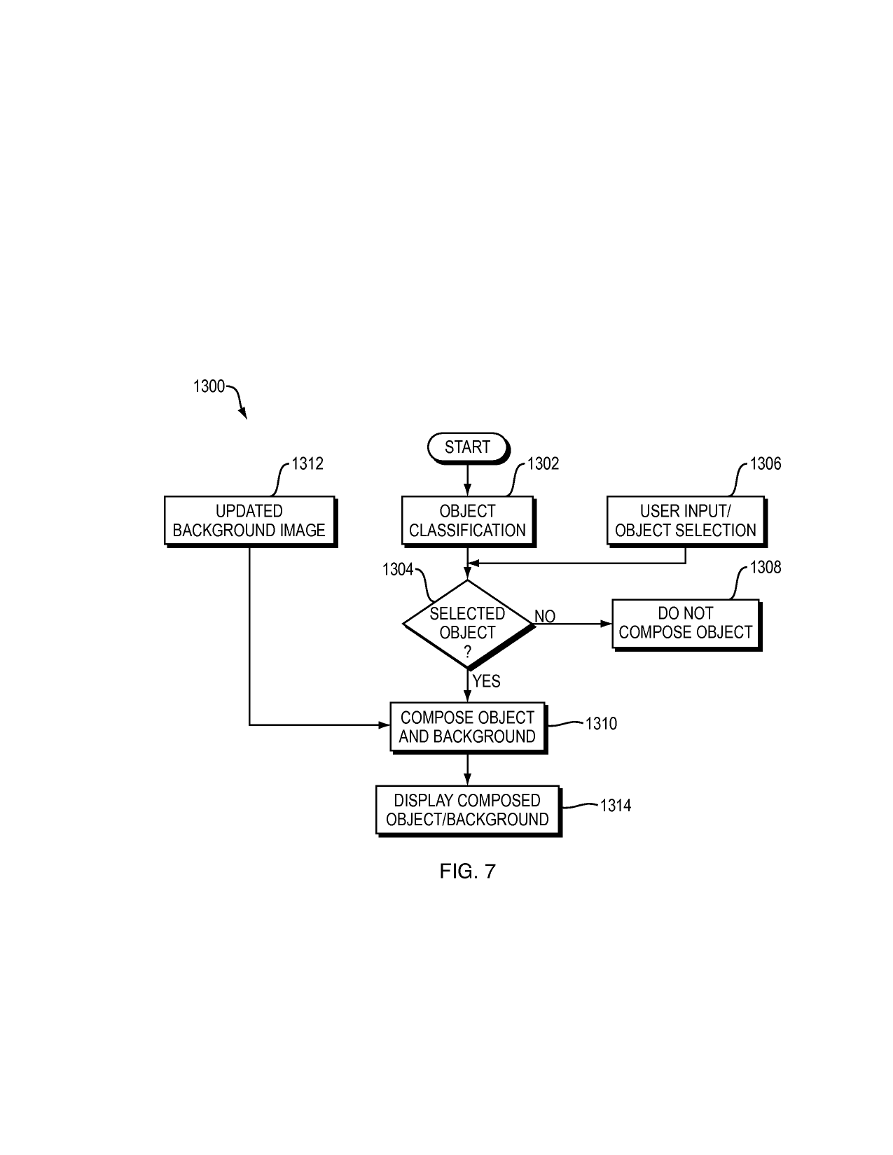

FIG. 7 illustrates a flow diagram for an exemplary embodiment of a process for composing an image for display. Process 1300 starts at block 1302 where the processor receives object classifications such as from block 1406 in FIG. 6. At decision 1304, the processor determines if the object classification is one selected by a user based on the information received from block 1306. If the received object classification does not match the user selected object classification, then at block 1308 the processor ignores the object and does not stitch the object to the background. If the received object classification does match the user selected object classification, then processor proceeds to block 1310 where it composes the object with the updated background image received from block 1312. The composed object/background image is then generated for display at block 1314.

It is not necessary to stitch all of the tracked objects from different frames to the background. Some of the objects can be selected. Larger objects along the track will be selected within a group of objects, and the objects that are not overlapped will be stitched. In order to show the order of the motion of the object, a colored line can be overlapped along the center of the objects. Different colors can represent different times. One exemplary way is to use a brighter color to represent the time closer to the end of the life cycle of the object. One storyboard can contain one or more different objects depending on the user's request. If a user wants to browse events quickly to check if there are abnormal object motions, multiple objects tracked at different time can be composed to one story board. Another presentation method is to stitch objects to the background along the time the objects selected to display. In this way, multiple fast moving objects can be displayed in a re-composed video.

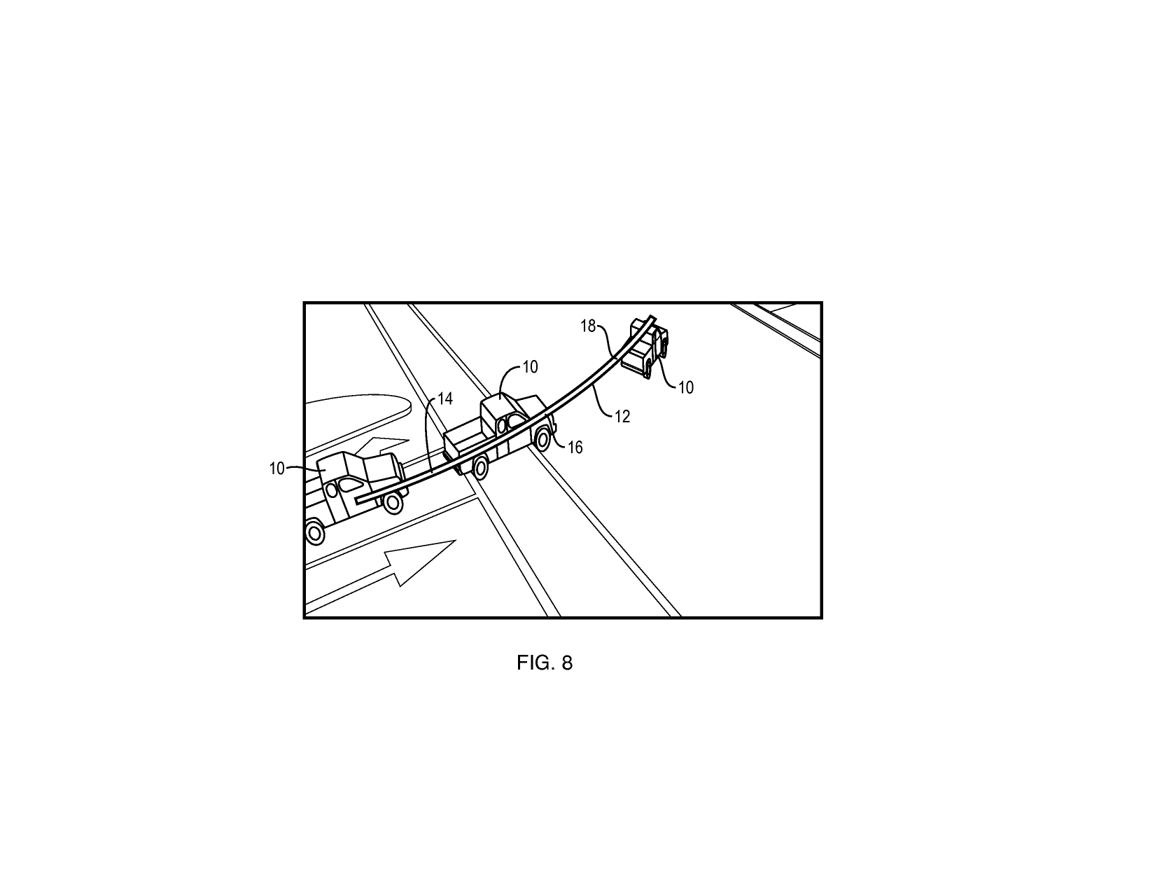

FIG. 8 is an exemplary illustration of a storyboard image created using one or more discussed embodiments. In this illustration, the object classification selected by a user is a vehicle. An exemplary vehicle 10 is show in the illustration. In this instance three images of the object are shown in the image at different points in time. Line 12 indicates the trajectory or path of movement of the selected object, that is, vehicle 10. Line 12 can provide an indication of the period of time that vehicle 10 moves along line 12. Line 12 can gradually change in intensity from the beginning of the displayed movement path until the end, or segments of line 12 can be in different colors to indicate, for example, the beginning, middle, and end portions of movement along the path. Line 12 has been illustrated in FIG. 8 as having three sections, 14, 16, and 18, which could be different colors or of varying intensity. 100441 More than one object and path can be shown on a single storyboard, such as, for example, where a user selects the classification vehicles and two vehicles are in the scene during at least a portion of the time period to be displayed in the storyboard. In this case the processor stitches the mulitple foreground-objects in the selected foreground-object classification onto the background portions. These multiple foreground-objects are displayed on their respective paths resulting in a storyboard with multiple images of multiple objects on multiple paths.

Substantial variations to described configurations can be made in accordance with specific requirements. For example, customized hardware might also be used, and/or particular elements might be implemented in hardware, software (including portable software, such as applets, etc.), or both. Further, connection to other computing devices such as network input/output devices can be employed.

The terms “machine-readable medium” and “computer-readable medium,” as used herein, refer to any medium that participates in providing data that causes a machine to operate in a specific fashion. Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions and/or code. Various forms of computer-readable media can be involved in carrying one or more sequences of one or more instructions to a processor(s), such as processors 204 and 304 of transmitter 102 and receiver 106 respectively, for execution. Merely by way of example, the instructions can initially be carried on a magnetic disk and/or optical disc of transmitter 102. Transmitter 102 might load the instructions into its dynamic memory and send the instructions as signals over a transmission medium to be received and/or executed by receiver 106. These signals, which might be in the form of electromagnetic signals, acoustic signals, optical signals and/or the like, are all examples of carrier waves on which instructions can be encoded, in accordance with various configurations of the invention.

Storyboard as used herein is defined as a single image displaying a sequence of foreground object images for the purpose of presenting an image to a user to assist in visualizing the motion of the foreground object during the period of time covered by the sequence of foreground object images. One storyboard can present one or more objects based on the user input.

The methods, systems, and devices discussed above are examples. Various configurations can omit, substitute, or add various procedures or components as appropriate. For instance, in alternative configurations, the methods can be performed in an order different from that described, and that various steps can be added, omitted, or combined. Also, features described with respect to certain configurations can be combined in various other configurations. Different aspects and elements of the configurations can be combined in a similar manner. Also, technology evolves and, thus, many of the elements are examples and do not limit the scope of the disclosure or claims.

Specific details are given in the description to provide a thorough understanding of example configurations (including implementations). However, configurations can be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes can be made in the function and arrangement of elements without departing from the spirit or scope of the disclosure.

Further, the preceding description details a video presentation system. However, the systems and methods described herein can be applicable to other transmission and presentation systems. In a surveillance system, the systems and methods described herein can be implemented on the edge devices, such as IP cameras or smart encoders, or they can be implemented on the the head-end, such as a video recorder, workstation, or server.

Also, configurations can be described as a process which is depicted as a flow diagram or block diagram. Although each can describe the operations as a sequential process, many of the operations can be performed in parallel or concurrently. In addition, the order of the operations can be rearranged. A process can have additional steps not included in the figure. Furthermore, examples of the methods can be implemented by hardware, software, firmware, middleware, microcode, hardware description languages, or any combination thereof When implemented in software, firmware, middleware, or microcode, the program code or code segments to perform the necessary tasks can be stored in a non-transitory computer-readable medium such as a storage medium. Processors can perform the described tasks.

Having described several example configurations, various modifications, alternative constructions, and equivalents can be used without departing from the spirit of the disclosure. For example, the above elements can be components of a larger system, wherein other rules can take precedence over or otherwise modify the application of the invention. Also, a number of steps can be undertaken before, during, or after the above elements are considered. Accordingly, the above description does not limit the scope of the claims.

What is claimed is:

1. A method of presenting video comprising: receiving a plurality of video data from a video source; analyzing the plurality of video data; identifying the presence of foreground-objects that are distinct from background portions in the plurality of video data; classifying the foreground-objects into foreground-object classifications; receiving user input selecting a foreground-object classification; and generating video frames from the plurality of video data containing background portions and only foreground-objects in the selected foreground-object classification.

2. A method as recited in claim 1 further comprising: processing data associated with a foreground-object in a selected foreground-object classification based on a first update rate;
processing data associated with the background portions based on a second update rate;
transmitting data associated with a foreground-object in a selected foreground-object classification dynamically; and transmitting data associated with the background portions based on the second update rate, wherein the first update rate is greater than the second update rate,

3. A method as recited in claim 1 further comprising: receiving a user request for a storyboard image for a first foreground-object classified in a selected foreground-object classification; analyzing the generated video frames to obtain a plurality of frames containing the first foreground-object; and generating an image containing background portions and a plurality of images of the first foreground-object showing motion of the first foreground-object over a period of time.

4. A method as recited in claim 3 wherein the step of generating an image containing background portions and a plurality of images of the first foreground-object showing motion of the first foreground-object over a period of time comprises generating an image containing background portions and a plurality of images of the first foreground-object showing motion of the first foreground-object over a period of time without having any overlap between the plurality of images of the first foreground-object.

5. A method as recited in claim 3 wherein the step of generating an image containing background portions and a plurality of images of the first foreground-object showing motion of the first foreground-object over a period of time further comprises generating a line showing the direction of motion of the first foreground-object.

6. A method as recited in claim 5 wherein the step of generating a line showing the direction of motion of the first foreground-object comprises genrerating a line showing the direction of motion of the first foreground-object and an indication of a time period for the movement of the first foreground-object along the line.

7. A method as recited in claim 1 wherein the step of generating video frames from the plurality of video data containing background portions and only foreground-objects in the selected foreground-object classification comprises the step of stitching the foreground-objects in the selected foreground-object classification onto the background portions.

8. A system for presenting video comprising: a processor adapted to receive a plurality of video data from a video source, analyze the plurality of video data, identify the presence of foreground-objects that are distinct from background portions in the plurality of video data, classify the foreground-objects into foreground-object classifications, receive user input selecting a foreground-object classification, and generate video frames from the plurality of video data containing background portions and only foreground-objects in the selected foreground-object classification.

9. A system as recited in claim 8 wherein the processor is further adapted to process data associated with a foreground-object in a selected foreground-object classification based on a first update rate, process data associated with the background portions based on a second update rate, transmit data associated with a foreground-object in a selected foreground-object classification dynamically, and transmit data associated with the background portions based on the second update rate, wherein the first update rate is greater than the second update rate.

10. A system as recited in claim 8 wherein the processor is further adapted to receive a user request for a storyboard image for a first foreground-object classified in a selected foreground-object classification, to analyze the generated video frames to obtain a plurality of frames containing the first foreground-object, and generate an image containing background portions and a plurality of images of the first foreground-object showing motion of the first foreground-object over a period of time.

11. A system as recited in claim 10 wherein the processor is further adapted to generate an image containing background portions and a plurality of images of the first foreground-object showing motion of the first foreground-object over a period of time.

12. A system as recited in claim 10 wherein the processor is further adapted to generate an image containing background portions, a plurality of images of the first foreground-object showing motion of the first foreground-object over a period of time, and a line showing the direction of motion of the first foreground-object.

13. A system as recited in claim 12 wherein the processor is further adapted to a line showing the direction of motion of the first foreground-object and an indication of a time period for the movement of the first foreground-object along the line.

14. A system as recited in claim 8 wherein the processor is adapted to stitch the foreground-objects in the selected foreground-object classification onto the background portions.

15. A non-transitory computer readable medium comprising instructions configured to cause a processor to: receive a plurality of video data from a video source, analyze the plurality of video data, identify the presence of foreground-objects that are distinct from background portions in the plurality of video data, classify the foreground-objects into foreground-object classifications, receive user input selecting a foreground-object classification, and generate video frames from the plurality of video data containing background portions and only foreground-objects in the selected foreground-object classification.

16. A non-transitory computer readable medium as recited in claim 15 further comprising instructions configured to cause the processor to: process data associated with a foreground-object in a selected foreground-object classification based on a first update rate; process data associated with the background portions based on a second update rate; transmit data associated with a foreground-object in a selected foreground-object classification dynamically; and transmit data associated with the background portions based on the second update rate, wherein the first update rate is greater than the second update rate.

17. A non-transitory computer readable medium as recited in claim 15 further comprising instructions configured to cause the processor to: receive a user request for a storyboard image for a first foreground-object classified in a selected foreground-object classification; analyze the generated video frames to obtain a plurality of frames containing the first foreground-object; and generate an image containing background portions and a plurality of images of the first foreground-object showing motion of the first foreground-object over a period of time.

18. A non-transitory computer readable medium as recited in claim 17 wherein the instructions to generate an image containing background portions and a plurality of images of the first foreground-object showing motion of the first foreground-object over a period of time comprise instructions configured to cause the processor to generate an image containing background portions and a plurality of images of the first foreground-object showing motion of the first foreground-object over a period of time.

19. A non-transitory computer readable medium as recited in claim 17 wherein the instructions to generate an image containing background portions and a plurality of images of the first foreground-object showing motion of the first foreground-object over a period of time further comprise instructions configured to cause the processor to generate a line showing the direction of motion of the first foreground-object.

20. A non-transitory computer readable medium as recited in claim 19 wherein the instructions configured to cause the processor to generate a line showing the direction of motion of the first foreground-object comprise instructions to cause a processor to generate a line showing the direction of motion of the first foreground-object and an indication of a time period for the movement of the first foreground-object along the line.

21. A non-transitory computer readable medium as recited in claim 15 wherein the instructions to generate video frames from the plurality of video data containing background portions and only foreground-objects in the selected foreground-object classification comprise instructions to cause a processor to stitch the foreground-objects in the selected foreground-object classification onto the background portions.

22. A method as recited in claim 1 wherein the step of classifying the foreground-objects into foreground-object classifications comprises the steps of: calibrating the object with perspective transform to determine the physical size; initially classifying the object based on its physical size and moving direction with either Gaussian probability modes or deterministic models; determining if the object size is between the size of a group of people and a vehicle; smoothing the vertical shape profile of the motion blob if the object size is between the size of a group of people and a vehicle; and analyzing the smoothed vertical shape profile of the motion blob to identify the object as either a group of people or vehicle based on the number of peaks on the profile.
